(19) United States
(12) Patent Application Publication
(10) Pub. No.: US 2014/0190491 A1
(43) Pub. Date: Jul. 10, 2014

(54) Device and Methods for Treatment of Bruxism and TMJ Disorder

(71) Applicant: Rene Garcia, Washington, IL (US)

(72) Inventor: Rene Garcia, Washington, IL (US)

(21) Appl. No.: 14/137,173

(22) Filed: Dec. 20, 2013

Related U.S. Application Data
(60) Provisional application No. 61/750,337, filed on Jan. 8, 2013.

(51) Int. Cl. A61C 5/14

(52) U.S. Cl. CPC A61C 5/14
USPC 128/861

(57) ABSTRACT

The present invention relates to a device and method of treating temporomandibular joint disorder (TMJ) and bruxism by placement in the mouth of an individual with a dental mouth guard to produce a minor irritation of the palate of a person suffering from temporomandibular joint disorder (TMJ) and bruxism through one or more irritation teeth or spines that mildly irritate the palate of a wearer when tooth grinding or maxillary pressure occurs. The mouth guard includes an irritation plate and a tooth molding for placement and fitting to a patient's upper dentition. The irritation plate employs irritation spikes whereupon commencing of tooth grinding initiate minor irritation to the palate of a wearer wherein, the wearer is alerted to the occurrence of tooth grinding, whether the wearer is sleeping or awake. The irritation plate also employs use of two “wings” that engage the wearer's teeth upon commencement of tooth grinding.

### FIELD OF THE INVENTION

This application claims the benefit of U.S. Provisional Application No. 61/750,337, filed Jan. 8, 2013, the substance of which is incorporated herein in its entirety. The present invention relates generally to a device and methods that assist in preventing teeth clenching and grinding in sleeping individuals and more specifically, to a device that effectively treats and prevents bruxism.

### BACKGROUND OF THE INVENTION

Bruxism has been defined as excessive grinding or clenching of teeth. The behavioral pattern occurs during sleep or during waking hours and is an involuntary often resulting from stress or habit. Surprisingly, over 80% of individuals with bruxism are completely unaware of the occurrence. As might be expected, bruxism often exerts powerful forces on teeth, gums and joints in the mouth resulting in wearing of the teeth, often over a number of years. Bruxism is often associated with several symptoms and health effects including tooth abrasion, fractures and tooth loss, gum recession, dental caries, alveolar bone loss, headaches, difficulties in opening the mouth, ear aches and hearing loss, neuralgia, tenderness, pain or fatigue of facial muscles and has been implicated to be the leading cause of several temporomandibular disorders (TMDs).

Presently, several causes are associated to bruxism and vary from patient to patient. Stress, emotions and other psychological factors have been suggested to result in an increase in the frequency of bruxing episodes, although there is no direct evidence that stress itself is a contributing factor to the onset of bruxism. There is also little evidence that a decrease in stress level results in a decrease or cure to bruxism.

Still other evidence has suggested that bruxism may be traceable to drugs or excessive consumption of alcohol. In other cases, bruxism may be associated with malformations in the jaw itself or to abnormal dental occlusion.

Despite extensive study of the condition, an effective treatment for bruxism remains elusive. Over the years, several patents have disclosed devices and methods which seek to provide treatment and prevention of this chronic condition. For example, U.S. Pat. No. 6,302,110 to Yoshida, describes a dental protector for use against bruxism. Specifically, the patent discloses a U-shaped mouth guard adapted to cover the occlusal faces of the teeth and a second part adapted to cover the posterior surfaces of the teeth so to prevent clenching or grinding of the teeth. A unique character of the device is provided by utilizing an occlusal portion which softens at near body temperature thus allowing the device to form fit onto the user's teeth. However, the device fails to provide a device or method that effectively breaks the habit of bruxing and also fails to provide any means by which the individual becomes aware that he is bruxing.

Likewise, U.S. Pat. No. 5,511,562 to Hancock discloses a dental device for treating temporomandibular joint disorders (TSDs). Specifically, the device includes a generally U-shaped mouth guard having an inner and outer side wall with a plurality of connectors positioned between the inner and outer side walls. A pliable material fills the upper and lower compartments of the device so that the grinding or clenching by the patient is prevented and the mandible can be set in a desired position. Like the '110 patent however, the '562 patent fails to provide a method or device that counteracts the chronic condition of bruxism and also fails to communicate when bruxing is taking place, a shortcoming not addressed by the prior art.

U.S. Pat. No. 4,568,280 to Ahlin discloses a craniomandibular appliance comprising a thermoplastic dental arch that is inserted into a patient's mouth. The dental arch is moldable within the mouth to a fixed configuration so that a predetermined mandibular position can be obtained. In order to mold the device, it must be preheated to a temperature above 200° F. by submerging in boiling water. The device however, fails to address the shortcomings of the prior art because it is composed entirely of thermoplastic material so that the entire device becomes malleable when heated, leaving open the possibility that it may harden in an incorrect configuration when removed from the heat if the patient's mandible is not properly positioned.

U.S. Pat. No. 3,924,638 to Mann shows a tension reliever intended to be inserted into a patient's mouth. The device is made of a thermosetting plastic so that it will maintain a rigid form once heated. In a preferred embodiment, the rigid lower surface of the device is lined with softer materials. This softer material, however, is not adapted to form around a user's teeth in such a manner so as to set the mandible in a proper position. Rather, it merely is used to allow the patient to grind his or her teeth without causing any damage to the teeth. Moreover, the device fails to alert the wearer that bruxing is occurring and does not allow the formation of habits tending away from bruxing, either during sleep or waking hours.

Still others have attempted to provide devices and methods to advance development of therapeutic habits through use of biofeedback mechanisms so to alert an effected individual that bruxing is occurring. U.S. Pat. No. 6,164,278 to Nissani for example, discloses a taste-based approach to the prevention of teeth clenching and grinding. Specifically, the mouth piece provides a mildly aversive, safe, liquid that is inserted into and sealed in, small, bilaterally-sleeved, polyethylene capsules. Two capsules are attached to a specially constructed dental device which places the capsules between the lower and upper teeth.

The device and capsules are worn at night or at other times when bruxism is suspected to occur. When bruxing in the individual begins, the capsules rupture and the liquid is released into the mouth which then draws the patient's conscious attention to, and forestalls, any further attempt of teeth clenching or grinding. Although the device and capsules may tend to alert the individual that bruxing is occurring the device fails to address the failings of the prior art in that such capsules must be continually replaced and there remains some question as to whether the capsules are effective in actually awakening a sleeping individual since it is foreseeable that the liquid material may leak from the mouth during sleep. Further, it is difficult to accurately gauge at what pressure the capsules should rupture. For example, it is conceivable that such capsules might rupture prematurely or by mistake during waking hours rendering the device less than effective in minimizing the bruxing habit.

By contrast, the present invention is constructed without the necessity and provision of replacement parts such as the capsules of the '278 patent to fit in the mouth comfortably and providing minor irritation to alert the wearer that bruxing is occurring. It also does not require the consideration of whether capsules are ruptured at the correct time and manner but rather rely on a constant mechanism for alerting the wearer of the occurrence of bruxing, whether during sleep or in waking hours. Moreover, the present invention assists in forming positive habits in preventing bruxism so to prevent the wear of teeth over time and the occurrence of any of several temporomandibular disorders (TMDs).

### SUMMARY OF THE INVENTION

The present invention relates to a mouth guard and methods of use to aid in the treatment of bruxism and temporomandibular joint (TMJ) disorder including an adjustable thermoplastic tooth molding, the mouth guard further containing sections for placement and fitting to a patient's upper dentition. Also within the scope of the invention is an irritation plate that is prepared with lower “wings” that engage the teeth of a wearer at the lower portion of the irritation plate, the irritation plate also possessing irritation spines or “teeth” that cause mild irritation to a wearer during times of tooth grinding or bruxing. A separate section of the invention is the tooth molding which can be manufactured from any appropriate materials as known in the art. The tooth molding includes tooth channels or indentations that upon commencement of tooth grinding trigger minor irritation to the palate of a wearer via one or more faceted irritation spikes or spines located on the irritation plate. The wearer is alerted to the occurrence of tooth grinding, whether the wearer is sleeping or awake, whereupon the wearer ceases the tooth grinding thereby preventing development of temporomandibular joint (TMJ) disorder, tooth wear and other similar disorders.

The invention further relates to a dental mouth guard to aid in the treatment of bruxism and temporomandibular joint (TMJ) disorder that includes a section for placement and fitting to an individual's palate and upper dentition. The invention includes a tooth molding and an irritation plate, the tooth molding being prepared with tooth indentations or channels that, upon commencing of tooth grinding, applies pressure to the irritation plate upward causing the irritation spines to mildly irritate the upper palate of a wearer wherein, the wearer is alerted to the occurrence of bruxing, whether the wearer is sleeping or awake. Accordingly, the wearer ceases the tooth grinding thereby preventing development of temporomandibular joint (TMJ) disorder and tooth wear.

The invention further relates to a method of treating temporomandibular joint disorder (TMJ) and bruxism by placement in the mouth of an affected individual with a dental mouth guard to produce a minor irritation of the upper palate of a person suffering from temporomandibular joint disorder (TMJ) and bruxism through one or more irritation teeth or spines that mildly irritate the upper palate of a wearer when tooth grinding or maxillary pressure occurs. The mouth guard includes an irritation plate and a tooth molding for placement and fitting to a patient's upper dentition. The irritation plate employs irritation spikes, teeth or spines that, upon commencing of tooth grinding initiate minor irritation to the upper palate of a wearer by the irritation spines wherein, the wearer is alerted to the occurrence of tooth grinding, whether the wearer is sleeping or awake. The irritation plate also employs use of two “wings” that engage the wearer's teeth upon commencement of tooth grinding. The tooth molding is designed to allow the upper and lower teeth to engage the irritation plate. Accordingly, the wearer ceases the tooth grinding thereby preventing development of temporomandibular joint (TMJ) disorder and tooth wear.

### BRIEF DESCRIPTION OF THE DRAWINGS

FIG. 1A depicts a basic configuration of a preferred embodiment of the invention, namely the irritation plate of the invention. In the illustration, the irritation plate of the invention is shown with “wings” at the lower portion of the device and irritation spines, spikes or irritation “teeth” at the upper portion which act to exert pressure to the upper palate and mildly irritate during bruxing.

FIG. 1B depicts the embodiment from a side perspective. In the illustration, the irritation plate of the invention is shown with spikes or irritation “teeth” at the upper section to provide feedback to the user during bruxing. The device is also shown with an additional section of the invention envisioned within the scope of the preferred embodiment, namely a tooth molding portion that fits over the upper teeth and allows the irritation portion of the invention to fit therethrough.

FIG. 1C shows a view looking toward the upper palate wherein the wearer has the invention in place. Specifically, the wings of the irritation plate are shown below the canine teeth of the wearer and the tooth molding portion of the invention is shown placed over the upper teeth.

FIG. 1D is an alternative rendering of the two sections of the invention as they fit in a wearer's mouth. As illustrated, the tooth molding portion of the invention is fitted over the wearer's upper teeth while the irritation plate of the invention fits in the upper section of the mouth wherein the spikes or irritation teeth are able to access the palate.

FIG. 2A depicts the irritation plate illustrated with a typical retainer. Specifically, the irritation plate of the invention fits in the wearer's mouth in conjunction with a retainer. In the illustration, the irritation plate of the device fits through an opening in the retainer thus, allowing the spikes, or irritation “teeth” to fit therethrough and to access the wearer's palate during times of tooth grinding.

FIG. 2B depicts the retainer and the irritation plate of the invention in a wearer's mouth. As shown, the wearer's upper teeth fit in the retainer while the lower “wing” portion of the irritation plate of the invention fits over the wearer's upper canines The irritation spikes or “teeth” access the palate causing irritation during bruxing.

### DETAILED DESCRIPTION OF THE INVENTION

Current methods of treating teeth grinding, also commonly referred to as bruxing, are significantly lacking Several devices have been designed which purportedly provide effective treatments to assist in preventing an individual from teeth grinding however, all fall short of providing a device and method which assists an individual with development of therapeutic habits, which ultimately lead to a cessation of teeth grinding, a significant risk factor in the onset of temporomandibular joint (TMJ) disorder.

Biofeedback devices are available which alert an individual to the onset of bruxing but the high cost and complexity of such devices puts this type of treatment out of the reach of a large proportion of affected individuals. Moreover, complicated setup of such devices prior to sleep makes compliance with treatment an issue as well. In addition, such devices are designed only to work during sleep and do nothing to address bruxing during waking hours, which often occurs without the knowledge of the individual despite being awake.

Simpler devices have been offered but none address the shortcomings in effectively treating bruxing, namely in alerting the individual that tooth grinding is occurring, nor do they foster development of therapeutic habits which lead to grinding cessation. Devices that are available and designed to alert a bruxing individual to the onset of teeth grinding also suffer from shortcomings which render them less effective than the present invention. U.S. Pat. No. 6,164,278 for example, provides a mouth device in which “taste” and “flavor” capsules are employed which burst at the onset of bruxing in an individual resulting in an unpleasant taste which purportedly alerts the individual that bruxing has occurred. However, there is little evidence to show that the mildly aversive fluid contained in the capsules consistently alerts a sleeping individual that bruxing has commenced. This is especially true in those individuals in which the fluid might leak from the mouth due to sleeping with the mouth open.

Accordingly, the invention relates to a dental device and methods of its use to effectively treat bruxing to prevent the onset of temporomandibular joint (TMJ) disorder, a disorder associated with the occurrence of chronic teeth grinding and clenching. The dental device is composed of an irritation plate that includes irritation spines, teeth or spike lines which are activated whenever bruxing occurs. On commencement of bruxing, mild irritation of the upper palate is initiated directly by the pressure applied from the irritation plate which is employed in conjunction with either the tooth molding of the invention or with a typical tooth retainer. Also, as part of the invention, the mouth guard employs use of a tooth molding that fits over a wearer's top teeth and which aids in engaging the wearer's teeth to move the irritation plate upward during times of tooth grinding.

Specifically, the present invention relates to a mouth guard and methods of use to aid in the treatment of bruxism and temporomandibular joint (TMJ) disorder comprising a custom made irritation plate with a faceted irritation area and one or more lower wings. The invention also includes a tooth molding section for placement and fitting to a patient's upper teeth. The tooth molding is further designed to allow for comfortable sleeping and to prevent choking on saliva during times of sleep.

The invention is made up of two sections, the first section generally referred to as the irritation plate, the plate being prepared with one or more “wings” that engage the teeth of the upper jaw and which also possesses “irritation spikes” or “teeth” that, when engaged by the upper teeth of a wearer, causing the wearer irritation during instances of bruxing. The second section or portion of the invention is a separate tooth molding that fits over the upper teeth of a wearer so that the first portion fits within the tooth molding. During times of bruxing, the wearer's teeth engage the “wings” of the irritation plate, the irritation plate working in conjunction and together with the tooth molding, and when a wearer begins bruxing, the irritation spikes access and irritate the wearer's palate, causing the wearer to stop grinding his or her teeth together, thereby preventing further bruxing by the wearer.

The irritation plate, upon commencing of tooth grinding, triggers minor irritation to the palate of a wearer via the irritation area wherein, the wearer is alerted to the occurrence of tooth grinding, whether the wearer is sleeping or awake, whereupon the wearer ceases the tooth grinding thereby preventing development of temporomandibular joint (TMJ) disorder, tooth wear and effectively breaking the user grinding habit.

A preferred embodiment of the invention employs use of an irritation section or plate which is engaged when the wearer clenches the upper and lower teeth and the wing of the irritation plate is pushed upward resulting in the rise of the irritation area and mild irritation of the palate. The degree of irritation changes depending on the level of pressure exerted by the lower maxilliary during times of grinding.

The term “bruxing” as used herein refers to the occurrence of tooth grinding or clenching in an individual. In most cases, the term refers to a chronic occurrence but may also refer to only occasional tooth grinding. The term also refers to the occurrence of teeth grinding during sleep or waking hours and occurs whether the individual is aware of the tooth grinding or is currently unaware that grinding is taking place. Generally, bruxing will be understood to be a factor in the onset of temporomandibular joint (TMJ) disorder.

The term “spike lines”, “spine lines” “irritation teeth”, “irritation spikes”, “spikes”, “teeth” or “irritation area” as used herein refers to the section of the invention that provides a mild irritation to the upper palate of a wearer to alert of the occurrence of bruxing. Generally, any portion of the invention, regardless of configuration, that acts to mildly irritate the upper palate of a wearer, will be designated as a spike line or as spine lines.

The term “mildly irritating”, “mild irritation” as used herein refers to the minor discomfort to an individual absent breaking of the skin or abrasiveness which results in tearing of the skin or palate tissues.

The present invention generally provides a mouthpiece including two main sections designed to assist an individual in developing therapeutic habits in reducing or eliminating the occurrence of bruxing either during sleep or waking hours. In doing so, the invention provides a section, specifically, a tooth molding to fit the upper jaw and teeth of an individual, the tooth molding being made to fit the upper teeth, the portion allowing the wearer to sleep comfortably and allowing normal breathing without choking on saliva. The second portion, generally referred to as an irritation plate, and is made to form one or more “wings” that fit underneath the upper teeth of a wearer. The upper section of the irritation portion is prepared with irritation spikes or “teeth”. When the wearer begins grinding his or her teeth, the wings are engaged by the grinding action of the teeth causing upward movement of the irritation plate, thus causing the irritation spikes to mildly irritate the palate of the wearer. The wearer thereafter ceases grinding his or her teeth.

The irritation mechanisms of the invention as envisioned herein are designed to irritate the palate following initiation of bruxing by clenching of the teeth. In an alternative preferred embodiment, the irritation plate of the invention is used in conjunction with a typical dental retainer. As shown in the figures herein, the irritation portion of the invention fits within the upper section of a typical retainer. During times of tooth grinding, the wings of the irritation plate of the device are engaged by the teeth causing the irritation spikes to mildly irritate the palate of the wearer causing the wearer to cease bruxing.

In a preferred embodiment of the invention the dental device fits the mouth and will be custom made to conform to the wearer's palate inside the mouth. In one embodiment, a flexible material is employed. The flexible material makes up the tooth molding that fits over a wearer's upper teeth and is also custom made to fit each individual wearer. As envisioned herein, both sections of the invention need not be custom made and can be mass produced in a “one size fits all” configuration. The irritation plate of the invention fits within the tooth molding and is made up of “wings” that cause a movement of the portion in an upward fashion upon commencement of tooth grinding. Upon commencement of tooth grinding, the irritation spikes or “teeth” at the top section of the irritation plate also move up and irritate the wearer's palate. When clenching of the teeth begins, the teeth apply force on the moveable section of the irritation plate resulting in an upward force upon the lower portion of the plate. In doing so, the force moves the portion of the irritation plate upward and initiates mild irritation of the palate via one or more irritation spines lines situated at the top of the face plate, alerting the individual of the occurrence of bruxing.

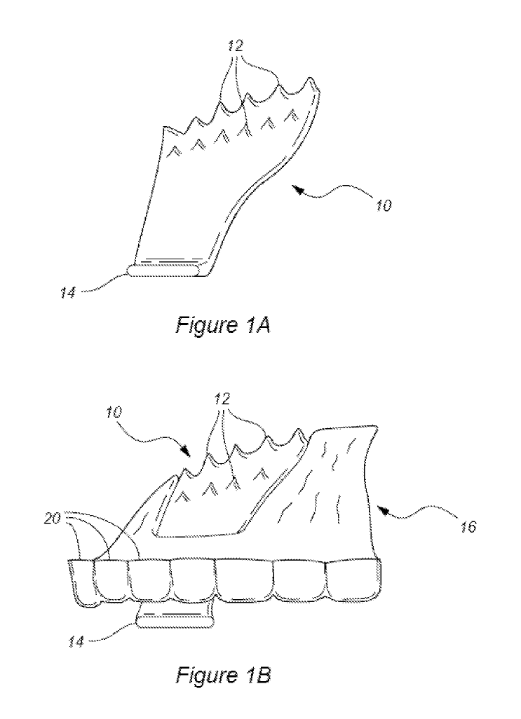

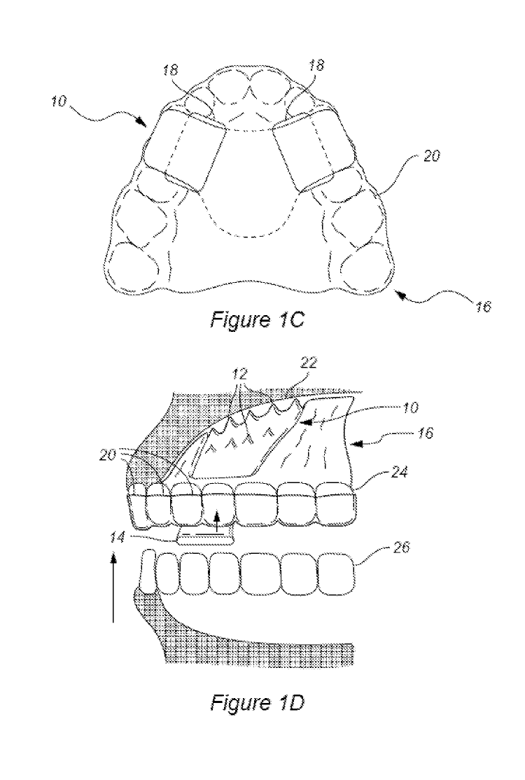

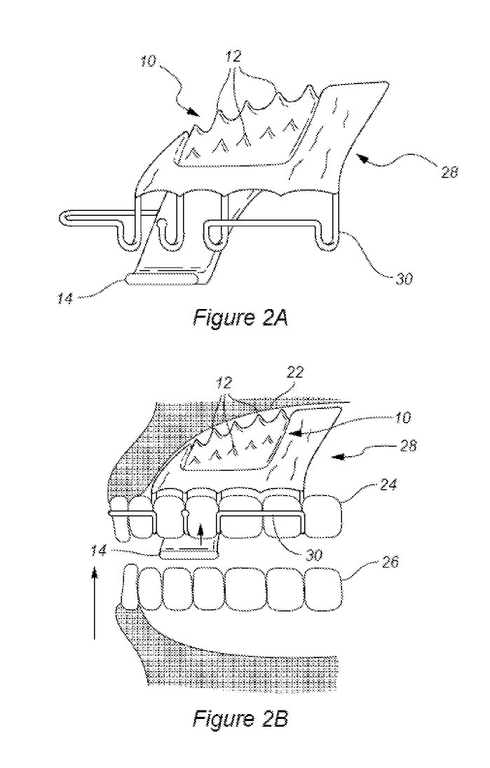

In yet another preferred embodiment, the dental device of the present invention envisions several preferred embodiments wherein the irritation portion of the plate fits with either the tooth molding or with a typical retainer. For example, the irritation portion can be configured with the tooth molding as shown in FIGS. 1B, 1C or 1D or the irritation plate can be employed with a typical retainer as shown in FIGS. 2A and 2B.

In yet another preferred embodiment, the present invention uses molded wire to hold the mouth guard to the user, similar to the one uses in orthodontic retainers also known as Hawley Retainer.

Reference is now made to FIGS. 1A-D and 2A and 2B, which illustrate various embodiments of the invention.

FIG. 1A shows a side view perspective of a preferred embodiment of the invention 10. Specifically, the element illustrated depicts the irritation plate which is prepared with irritation spines or “teeth” 12. At the lower section of the irritation plate is the “wing” 14, that when depressed by the wearer's teeth, cause an upward movement and mild irritation of the wearer's palate. A preferred embodiment of the invention has a second “wing” which isn't viewed in the Figure.

FIG. 1B shows the device when used in conjunction with the tooth molding portion of the invention 16. Specifically, the tooth molding fits over the wearer's top teeth, upper jaw with accommodation for the wearer's teeth in the form of tooth indentation or channels 20. When teeth are clenched, the wing of the irritation plate, the irritation spines move upward and mildly irritate the wearer's palate. The wearer is then alerted to the occurrence of tooth grinding whether awake or asleep.

FIG. 1C illustrates a view of the irritation plate and the tooth molding as seen from below and looking upward inside a wearer's mouth. Specifically, the tooth molding 16 covers the wearer's teeth by accommodating the teeth with tooth indentations 20. The tooth molding is prepared with two holes 18 wherein the irritation plate 10 fits therethrough allowing the wings to engage the wearer's top teeth.

FIG. 1D illustrates a side view perspective of how the irritation plate and the tooth molding fit within a wearer's mouth. Specifically, the irritation plate 10, with irritation spines 12 pointing upward, is configured to fit within the tooth molding 16. During times of tooth clenching between the lower teeth 26 and the upper teeth, 24 engage the wings 14 of the irritation device causing the irritation plate to move upward in the wearer's mouth. As the irritation plate moves upward, the irritation spines or “teeth”, mildly irritate the wearer's palate 22, alerting the wearer that he is grinding his teeth, whether the wearer is asleep or not.

FIG. 2A illustrates an alternative embodiment of the irritation plate 10 and wings 14 as used with a typical retainer 28. Specifically, the irritation plate is configured to fit within the retainer so that the irritation spines or “teeth” 12 point upward. The retainer wiring 30 and retainer itself is designed to function as would a typical retainer.

FIG. 2B illustrates a side view perspective of how the irritation plate fits within a wearer's mouth employing use of a typical retainer rather than the tooth molding previously described. Specifically, the irritation plate 10 fits within the retainer 28 with irritation spines 12 pointed upward. Similar to the mechanism described above, during instances of tooth grinding, the wings 14 of the irritation plate are engaged by the upper 24 and lower teeth 26, via interaction with the retainer wiring 30, causing the irritation to move upwards. In doing so, the irritation spines mildly irritatie the palate of a wearer alerting the wearer to the occurance of bruxing, or tooth grinding, whether the wearer is aware of the grinding or not.

To prepare the molded sections of the device, a thermoplastic resin is employed to provide ease of manufacturing and low cost in preparing the device. For manufacturing the upper and lower jaw channels, materials such as those known in the art may be utilized. For example, ethylene-vinyl acetate copolymer is used however other materials such as polyurethane, silicone resin, poly (vinyl acetate) and other appropriate materials may be employed likewise. To prepare the molded wire a technique similar to the one utilized to fabricate the Hawley retainers can be utilized.

The manufacturing process is summarized in the following steps: Obtaining the patient upper maxillary model which includes a model of the patient's palate. Creating a cast-model. Use of a wax sheet (1 mm to 3 mm) spacer, positioning over the palate of the model (shaped as the desired plate). Making the holes in the wax to allow positioning of the irritation spines or “teeth”. Mixing two acrylic materials to create the irritation plate and wings. Pouring over wax (holes in the wax will allow the irritation spines or “teeth” to protrude. Once the activation plate is dry, removing the model and finishing the plate by grinding, removing sharp edges and forming to the desired shape. Repositioning the irritation plate in the model and employing use of a vacuum to form the final shape of the plate.

In preparing the irritation plate, the manufacturing process is analogous to the methods employed in preparing a typical retainer and can be summarized according to the following steps: The irritation plate is fabricated by employing use of a substances such as for example, wax wherein a space is kept for accommodation of the irritation spines, or “teeth”. Next, mixing of acrylic materials, for example monomers and polymers as known in the art are employed, placing the mixture in the mouth model of a dental patient and creating a maxillary/palate model by hand. Once the irritation plate is completed, equipment as known in the art are employed to warm the acrylic (invisacryl) sheets and install the model irritation plate to (with a vacuum in the bottom to form it). In forming the tooth molding, acrylic is thermoformed with the warmed acrylic being extracted of air by use of a vacuum system, allowing the acrylic to thermoform over a dental model and the irritation plate, later cutting holes in the tooth molding in order to accommodate the wings of the irritation plate.

Injection molding is accomplished by large machines called injection molding machines. Resin is fed to a machine through what is called a hopper. Colorants are fed to the machine directly after the hopper. The resins enter the injection barrel by gravity though the feed throat. Upon entrance into the barrel, the resin is heated to the appropriate melting temperature. The resin is injected into the mold by a reciprocating screw or a ram injector. The reciprocating screw offers the advantage of being able to inject a smaller percentage of the total shot (amount of melted resin in the barrel). The ram injector must typically inject at least 20% of the total shot while a screw injector can inject as little as 5% of the total shot.

The mold is the part of the machine that receives the plastic and shapes it appropriately. The mold is cooled constantly to a temperature that allows the resin to solidify and be cool to the touch. The mold plates are held together by hydraulic or mechanical force. The clamping force is defined as the injection pressure multiplied by the total cavity projected area. Typically molds are overdesigned depending on the resin to be used. Each resin has a calculated shrinkage value associated with in.

Certain advantages can be obtained in utilizing the present invention to treat bruxism and in preventing the onset of temporomandibular joint (TMJ) disorder. Foremost, the simplicity of the mouth guard in manufacturing results in significant savings to the consumer maximizing the market potential for the device. The present invention is also effective because it produces a minor irritation to the user without the need to replace the so-called “flavor” capsules offered by other devices. Moreover, the invention bypasses the significantly expensive biofeedback devices that require electronic monitoring and electric impulses to alert the wearer of the onset of bruxing. Such devices, due to their high cost, are out of the reach of a significant portion of the market requiring treatment for bruxing and prevention of TMJ.

The long term benefits of using the device are significant as well. Tooth wear over the course of one's lifetime results in tooth loss later in life and other disorders related to the mouth which adversely affect the lifestyle of the individual. Significant cost savings are also realized in that a wearer of the invention may forego the expense of adult orthodontics surgery or other treatments.

In realizing yet another advantage, the present invention will provide patients with an effective option in the treatment for bruxing, thus, addressing a critical unmet need. Further, the invention fosters formation and development of positive therapeutic habits by alerting the wearer that bruxing is occurring, whether the individual is sleeping or awake.

Over an extended period of use, the wearer forms habits which avoid bruxing. Eventually, such habits diminish the need for any treatment and the individual is then able to live free of the debilitating effects of TMJ.

The present invention is also easily adapted to operate and fit into any individual because it is easily adjusted. It can also be worn in waking hours or during sleep so that the individual is alerted to the onset of bruxing anytime of the day or night.

Although the invention has been described with reference to the above examples, it will be understood that modifications and variations are encompassed within the spirit and scope of the invention. Accordingly, the invention is limited only by the following claims.

What is claimed is:

1. A dental mouth guard to aid in the treatment of bruxism and temporomandibular joint (TMJ) disorder comprising an irritation plate and a tooth molding, the irritation plate comprising one or more wing portions and one or more irritation spines, wherein said tooth molding is shaped to fit over the top teeth of a wearer, said tooth molding being shaped to allow the irritation plate to fit therein, wherein said irritation plate is engaged by said wearer's teeth upon commencement of tooth grinding, and during instances of tooth grinding, whereupon said irritation plate moves in an upward motion causing initiation of a mild irritation to the palate of said wearer by a rubbing motion produced by said irritation spines, wherein said rubbing motion and said mild irritation alerts the wearer to the occurrence of bruxing, whether the wearer is sleeping or awake, whereupon the wearer ceases the tooth grinding thereby preventing development of temporomandibular joint (TMJ) disorder and tooth wear.

2. The mouth guard of claim 1, further comprising an irritation plate that is adjustable so to fit wearers of various sizes.

3. The mouth guard of claim 1, wherein said tooth molding is either attached to said irritation plate or wherein each are separate pieces.

4. The mouth guard of claim 2, further comprising irritation spines that mildly irritate the palate of a wearer when teeth are clenched.

5. The mouth guard of claim 1, wherein said one or more wings is engaged by the upper teeth of a wearer during tooth grinding to begin said rubbing motion and said mild irritation.

6. The mouth guard of claim 1, wherein a tooth retainer is used in place of said tooth molding and said tooth molding is not employed.

7. The mouth guard of claim 6 wherein said tooth retainer is formed to allow the irritation spines of said irritation plate to protrude through to the palate of said wearer.

8. The mouth guard of claim 7 wherein said one or more wings is engaged by the teeth of a wearer during tooth grinding to begin said rubbing motion and said mild irritation.

9. The mouth guard according to claim 1 essentially as shown in any of FIGS. 1A, 1B, 1C, 1D, 2A or 2B.

10. The mouth guard of claim 1 wherein said wearer is relieved of the symptoms associated with TM or bruxing.

11. A method of treating bruxism and temporomandibular joint (TMJ) disorder comprising an irritation plate and a tooth molding, the irritation plate comprising one or more wing portions and one or more irritation spines, wherein said tooth molding is shaped to fit over the top teeth of a wearer, said tooth molding being shaped to allow the irritation plate to fit therein, wherein said irritation plate is engaged by said wearer's teeth upon commencement of tooth grinding, and during instances of tooth grinding, whereupon said irritation plate moves in an upward motion causing initiation of a mild irritation to the palate of said wearer by a rubbing motion produced by said one or more irritation spines, wherein said rubbing motion and said mild irritation alerts the wearer to the occurrence of bruxing, whether the wearer is sleeping or awake, whereupon the wearer ceases the tooth grinding thereby preventing development of temporomandibular joint (TMJ) disorder and tooth wear.

12. The method of claim 11 further comprising an irritation plate that is adjustable so to fit wearers of various sizes.

13. The method of claim 11 wherein said tooth molding is either attached to said irritation plate or wherein each are separate pieces.

14. The method of claim 11 further comprising irritation spines that mildly irritate the palate of a wearer when teeth are clenched.

15. The method of claim 11 wherein said one or more wings is engaged by the teeth of a wearer during tooth grinding to begin said rubbing motion and said mild irritation.

16. The method of claim 11 wherein a tooth retainer is used in place of said tooth molding and said tooth molding is not employed.

17. The method of claim 11 wherein said tooth retainer is formed to allow the irritation spines of said irritation plate to protrude through to the palate of said wearer.

18. The method of claim 11 wherein said one or more wings is engaged by the teeth of a wearer during tooth grinding to begin said rubbing motion and said mild irritation.

19. The method of claim 11 wherein the mouth guard employed is essentially as shown in any of FIGS. 1A, 1B, 1C, 1D, 2A or 2B.

20. The method of claim 11 wherein said wearer is relieved of symptoms associated with TMJ or bruxing.
